(19) United States
(12) Patent Application Publication
(10) Pub. No.: US 2011/0154016 A1
(43) Pub. Date: Jun. 23, 2011

(54) METHOD FOR AGGREGATING INFORMATION VALUES IN A NETWORK

(75) Inventors: Saverio Niccolini, Heidelberg (DE); Jan Seedorf, Heidelberg (DE); Dirk Westhoff, Neustadt an der Weinstrasse (DE); Lindsay Frost, Speyer (DE)

(73) Assignee: NEC EUROPE LTD., Heidelberg (DE)

(21) Appl. No.: 13/000,148

(22) PCT Filed: Jun. 18, 2008
(86) PCT No.: PCT/EP2008/004898

§ 371 Date: Mar. 11, 2011

(51) Int. Cl. H04L 9/00

(52) U.S. Cl. 713/150

(57) ABSTRACT

A method for aggregating information values in a network, the network including trusted network nodes and untrusted network nodes, wherein a communication session is established by directing messages through the network along a network path from an originating network node (1) to a destination network node (3) thereby transiting hop-wise several intermediate network nodes (5, 7, 8, 9), wherein the information values are appended to the messages as per-hop information by network nodes (5, 7, 8, 9) along the network path, the appended information values being aggregated from hop to hop, is characterized in that the information values are encrypted before being appended to the messages, wherein the aggregation is performed on the encrypted information values.

The present invention relates to a method for aggregating information values in a network, the network comprising trusted network nodes and untrusted network nodes, wherein a communication session is established by directing messages through the network along a network path from an originating network node to a destination network node thereby transiting hop-wise several intermediate network nodes, wherein said information values are appended to said messages as per-hop information by network nodes along said network path, said appended information values being aggregated from hop to hop.

Methods of the above mentioned kind are widely spread nowadays and are applied in various fields, for instance in charging systems with respect to e.g. billing information. Another specific field of application, which will be exemplarily described in the following in some more detail, are modern multimedia systems which offer users an enormous variety of different services.

Multimedia systems are increasingly exposed to various forms of attacks which include, for instance, interruption of service attacks (i.e. Denial of Service, DoS) and social attacks (e.g. SPAM, SPam over Internet Telephony (SPIT), or VoIP Phishing). In the area of electronic mail unsolicited bulk email messages—so-called SPAM—have become very common and have turned into a severe problem. Not only companies that require email communication are impacted by SPAM messages, but also private users are very annoyed by SPAM. Many Internet users nowadays receive more SPAM messages than regular emails. For this reason, almost every server for incoming email uses SPAM filters which check incoming mails according to defined rules. They search, for example, actively for key words in the content of an email, they check specific configurations of the server used for sending the email or they search for senders that are often used for sending bulk emails. In case of a matching classification of an email as SPAM, it is marked and/or sorted out.

In the area of—analog or digital—telephony, SPAM (in this context referred to as SPIT, Spam over Internet Telephony) also occurs more and more often, as it can be seen, for example, in case of unsolicited commercial calls. These calls are mostly made by automated calling machines. Due to the currently and mainly employed switched telephone networks, such SPAM calls are very complicated and expensive which is the reason for a rather restricted number of SPAM calls. When Internet telephony will be used more commonly though, such SPAM calls will become much easier and cheaper, so a tremendous increase of SPAM calls in advanced modern multimedia systems will have to be assumed.

A severe problem is the detection of attacks to multimedia systems or, more specifically, to multimedia sessions between individual users. Today the detection of attacks to multimedia systems is performed mainly by using Intrusion Detection Systems (IDS). These IDS systems are able to monitor the traffic passing by and to take a local decision depending, for example, on the observed traffic structure or traffic content. Apart from such locally acting IDS systems, distributed attack detection schemes are already known in prior art.

A more sophisticated mechanism to deal with the above mentioned types of attacks is to evaluate a likelihood that each message of a multimedia session (e.g. INVITE, CANCEL, BYE, etc. in case of a SIP (Session Initiation Protocol) session) is malicious according to different methodologies at some of the intermediate network nodes (e.g. SIP proxy servers, application servers, session border controllers (SBCs), etc.) through which the session messages transit. Such mechanisms propose to append at each contributing network node a score to each evaluated message that indicates the maliciousness of that message and that, thus, constitutes a kind of reputation score. The single scores can then be evaluated together at each hop, for instance by summing them up. Depending on the resulting score, decisions can be made with respect to the further treatment of the messages or the session, respectively. For example, it may be decided to block messages in case the resulting score exceeds a predefined threshold. Alternatively, further inspections may be performed thereby applying advanced call handling and routing. For example, in VoIP applications such further inspections may include caller interaction checks, like a Turing Test (as described in detail in DE 10 2005 029 287 A1), a Voice Printing Test (as described in “Voice Printing and Reachability Code (VPARC) Mechanism for SPIT”, WIPRO, white paper), Audio CAPTCHA (Completely Automated Public Turing test to tell Computers and Humans Apart), grey-listing tests, etc.

The described mechanisms work quite well in environments in which only trusted nodes are involved, e.g. in a federation of hops (or domains). However, problems arise when the messages need to transit over peers that are not trusted. In such cases non-trusted peers may gain knowledge of information values appended to the messages along the network path from the originating network node to the destination network node. To give a concrete example of the involvement of non-trusted unauthorized parties, it is to be referred to peering among providers for interconnection of multimedia sessions which is currently being standardised by the IETF Speermint Working Group (“Session PEERing for Multimedia INTerconnect”). A first example scenario is that of a transit peering service provider (PSP) which is an external provider that enables peering between two providers. A second example scenario is that of an assisted peering service provider (A-PSP) which is also an external provider that serves as the hub for multiple service providers (SSPs) which do not need to have direct connection among each other but which rely on the A-PSP for routing calls to remote numbers that are unknown to the SSP. Even if such PSPs are trusted by the originating and terminating network node/domain in terms of specific aspects (like the provision of peering special services, such as QoS, billing, interoperability, routing, etc.), this peer may not be trusted regarding other aspects (like multimedia security scoring algorithms). Accordingly, it may not be desired for this peer to infer information on the multimedia score being exchanged between the originating and terminating domain. In general, it is considered to by a realistic scenario in multimedia signalling that a message traverses a server outside of a federation which provides external-services as stated above but which is not fully trusted with respect to certain information exchange, like e.g. security scoring.

The confidentiality problems as described above become clear by considering a specific example scenario from the field of unsolicited calls. If an entity sending unsolicited calls (i.e. SPIT) could monitor at some point in the call path the “reputation score” calculated for the calls as described above, then it would be possible for the entity to quickly adapt the characteristics of those unsolicited calls and see how to get “safe” scores to achieve the goal of spamming.

It is therefore an object of the present invention to improve and further develop a method of the initially described type in such a way that, by employing mechanisms that are readily to implement, an enhancement in terms of confidentiality is achieved.

In accordance with the invention, the aforementioned object is accomplished by a method comprising the features of claim 1. According to this claim, such a method is characterized in that said information values are encrypted before being appended to said messages, wherein said aggregation is performed on the encrypted information values.

According to the invention, it has first been recognized that currently available mechanisms do not address the case that some of the intermediate nodes may not by trusted. Furthermore, it has been recognized that confidentiality of information values forwarded in the system can not be guaranteed as non-trusted nodes along the network path are enabled to see which information values have been appended by other nodes. According to the invention, confidentiality of information values is preserved by encrypting said information values before being appended to the messages. The aggregation of the information values is then performed on the encrypted information values. Consequently, even by routing the messages through transit peers which are not fully trusted, these untrusted nodes can not infer information about information values appended by trusted nodes.

As regards a specific application scenario it may be provided that the messages to which said information values are appended are multimedia session messages. Such multimedia session messages may include VoIP messages, in particular VoIP messages based on-SIP (Session Initiation Protocol), email messages, etc.

According to a preferred embodiment, said information values include scoring values indicating the maliciousness of the messages. The maliciousness, or, more precisely, the likelihood or degree of maliciousness of a message may be determined by the network nodes by means of applying specific methodologies. These methodologies may include, but are not limited to Turing tests, voice printing tests, and/or grey-listing tests. Inspections performed to determine the maliciousness may be performed with or without performing interactions with the originating and/or with the destination network node. In particular, in case of VoIP calls, caller interaction may be useful and may yield relevant information.

Apart from maliciousness scoring, the information values may include scoring values which are generated by the network nodes and which indicate the delay caused by the respective previous network node of the network path. Such delay related information values may be used to determine Quality of Service (QoS) of a communication session established along the respective network path. Alternatively or additionally, the information values may include scoring values which are related to load-balancing information of the respective network node. According to a further embodiment functioning as charging system, the information values may include billing information wherein the billing may be calculated per hop, per session and/or per domain. Furthermore, information values related to fault detection may be employed.

Advantageously, the information values appended to the message along the network path are summed up at the destination network node. However, as the case may be, aggregation/summation can be performed at any arbitrary intermediate (trusted) network node. In case of a maliciousness scoring of multimedia session messages, such intermediate summation may prove advantageous as it may lead to a message blocking at an early stage, for instance when the accumulated score exceeds a certain threshold at an early point of the network path already.

As regards a high degree of simplicity, it may be provided that each of the network nodes which append information values to the message performs a separate encryption. Separate means that a network node does not take care of the encryption process performed by any other network node. The encrypted information values can then be appended in a list which may be attached to the message.

However, in many cases the straightforward way of separate encryptions does not constitute the optimal solution and proves to be disadvantageous in various aspects. In particular, it is not efficient when the number of network nodes/hops inserting the information values along the network path grows. The number of required decryption operations is then equal to the number of network nodes/hops along the network path that appended an information value to the message. In many cases, such kind of decryption is computationally too extensive to compute, in particular if asymmetric cryptography is applied.

According to an improved embodiment which widely avoids the above mentioned problems it may be provided that each of the network nodes which append an information value to the message performs an additively homomorphic encryption transformation.

An encryption algorithm is additively homomorphic if performing a specific algebraic operation on the ciphertext results in performing a (possibly different) algebraic operation on the plaintext. For example, an encryption scheme is additively homomorphic if a+b=D(E(a)+E(b)), where D( ) is the decryption operation and E( ) is the encryption operation and a, b are numeric plaintext values. With such an additively homomorphic encryption scheme it is possible to add two encrypted values without revealing them. The decryption operation would then result in the sum of these values.

Using additively homomorphic encryption transformations in order to aggregate the information values enhances the efficiency in terms of computational time for the intermediate/destination network nodes to take a decision towards the information values. The intermediate/final hop destined to check the information values, e.g. by calculating an overall malicious degree aggregated over the entire network path of a VoIP call, needs to perform only one decryption operation reducing therefore the computational time for such operation. This will allow the server on the decision-making node(s) to reduce the total time for the session handling which then impacts the number of sessions that can be handled in a certain amount of time. In case of e.g. VoIP the achieved reduction of computational time will either decrease the session set up time for a call or will allow the network node to handle a bigger amount of sessions while keeping the session setup time stable.

The reduction of computational time is also beneficial in terms of avoiding impact from DDoS (Distributed Denial of Service) attacks which particularly target the information value evaluation mechanism itself. If the decryption process at e.g. the receiving end introduces less computational overhead, bogus messages that target the decryption process, like Denial-of-Service “invalid encryption”, “replay” attacks, etc., become less effective.

According to a specific embodiment, a symmetric homomorphic encryption scheme is used for encryption. Such symmetric operation proves to be particularly advantageous when the trusted nodes along the network path constitute a federation. In that case it may be provided that all network nodes of the federation share a single symmetric key. As specific encryption algorithm the Domingo Ferrer scheme (as described in some detail in J. Domingo-Ferrer, ‘A Provable Secure Additive and Multiplicative Privacy Homomorphism’, Proceedings 5^{th} Information Theory Conference ISC'02, 2002) could be employed.

Alternatively, it may be provided that the network nodes of the federation share symmetric keys pairwise. In this case symmetric homomorphic encryption can be used as follows, for example by applying the scheme proposed by Castellucia, Mykletun and Tsudik (as described in C. Castellucia, E. Mykletun, G. Tsudik, ‘Efficient Aggregation of Encrypted Data in Wireless Sensor Networks’, 2^{nd} Conference on Mobile and Ubiquitous Systems: Networking and Services (Mobiquitous'05), July 2005). Each node on a hop would encrypt its information value with the key it shares with the receiving end node (e.g., in SIP signalling the last proxy on the path) and add this to the information value received from the previous hop. The node performing the decryption process needs to know the IDs of all nodes which contributed to the encrypted sum. With these IDs the decrypting node can derive a master key (from all the keys it shares corresponding to precisely this set of IDs) and perform the decryption resulting in the aggregated information value. In SIP signalling, each proxy adds it's ID to the message in the via-header, so the receiving proxy knows which IDs contributed to the encrypted value and it can derive the master key accordingly. The pre-requisite of this scheme is that a new node entering the federation of trusted nodes would need to conduct pairwise key-exchange procedures with all nodes in the federation. In a large federation with dynamic membership this may be disadvantageous compared to asymmetric encryption. Additionally, sharing a single key among all nodes might be considered dangerous because a single compromised node would leak all secrets shared within the federation.

Taking the above into consideration, an asymmetric homomorphic encryption scheme may be used for encryption which proves to be advantageous for larger groups due to the higher scalability. Appropriate asymmetric encryption operations include, but are not limited to the Okamoto-Uchiyama cryptosystem (described for example in T. Okamoto, S. Uchiyama, ‘A new Public-Key Cryptosystem as Secure as Factoring’, Eurocrypt'98), the Paillier cryptosystem (see for reference P. Paillier, ‘Public Key Cryptosystem based on Composite Degree Residuosity Classes’, Eurocrypt'99) and/or the Elliptic Curve ElGamal encryption together with a suitable mapping function (T. E. Gamal, ‘A public key cryptosystem and a signature scheme based on discrete logarithm’, Crypto'84).

With asymmetric homomorphic encryption, servers/nodes in a trusted federation share public keys among each other. Each node shares its public key only with trusted nodes to prevent untrusted nodes from adding an information value to the encrypted value. It is to be noted that under such a setting also the ‘public’ key is sensitive information. Each server has its own corresponding private key. Thus, any server in the federation can encrypt messages with the public key of the receiving destination network node (e.g., the proxy of the callee's domain in SIP signalling), and only this network node on the receiving end is able to decrypt messages.

By using a homomorphic encryption transformation, each trusted proxy on the way (which is part of a federation and has the public key of the final receiving proxy or of any other intermediate node destined for analyzing the aggregated information values) can encrypt its information value, add it to the previous information value, and then forward the message. Untrusted proxies are assumed not to be in possession of the public key of the receiving end-proxy. Any proxy on the path (trusted or not), cannot eavesdrop information values added on previous hops. The receiving end-proxy has to conduct only one decryption operation to receive the sum of all information values added on the path by servers which are in possession of its public key. Using asymmetric homomorphic encryption, a new node entering the federation would only have to distribute its public key to all members of the federation.

According to a further preferred embodiment, with each encryption process a freshness code is incorporated into the ciphertexts. By this means it is possible to effectively protect against the above already mentioned replay attacks and attacks against homomorphic encryption weaknesses. As such example of attacks one can think of a non-trusted intermediary node that can not decrypt received information values in the path, however, that may reuse an encrypted value on the path and insert it in some other message at the same end-proxy. Apparently, such attack would yield falsified results. As further example, a non-trusted intermediary node could add arbitrary values to the encrypted information values which again would affect the encrypted value. The proposed freshness value is designed and intended to detect these kinds of attacks and is included in the encryption at each hop. The freshness code may include an arbitrary bit-string. A dedicated service may be provided that generates these bit-strings frequently and from which trusted proxies may receive at any time the currently valid version. Alternatively, synchronised counters may be provided to calculate the current freshness value at any time. If an untrusted proxy inserts a formerly captioned encrypted information value, the receiving end (or any other network node destined for performing decryption) can detect that this information value is outdated after decryption by comparing the decrypted freshness value with the currently valid one. Additionally, if untrusted proxies add arbitrary values to the encrypted information values, this would also be detected at the receiving end because the received bits would not contain a multiple of the freshness value.

Weaving a freshness value into each ciphertext as described above proves to be useful both in case of applying symmetric and asymmetric encryptions. If a single symmetric key is shared by all the nodes in a federation, a freshness value is favourable to protect against attacks where non-trusted nodes (which are not in possession of the symmetric key shared among all nodes in the federation) can only add arbitrary and thus detectable values to the encrypted score. In case of asymmetric encryptions the introduction of freshness values is beneficial to protect against attacks where adversary nodes add bogus/arbitrary values to the encrypted information value despite not being in possession of the public key.

When performing the encryption, a node may apply the freshness value by performing the following transformation:

Eₖ(freshness_valueₜ|separation_bits|zero_bits|information value),

where k is the key used for encryption, freshness_value denotes the freshness value valid at the current time t. n pre-defined separation_bits are used to separate the information value from the freshness in the sum, and i zero_bits are used to handle overflow of the added information value. Information value is the actual information value consisting of m bits. When the receiving end performs the decryption it checks that the first k=message_length−(n+i+m) bits of the decrypted sum are a multiple of the freshness value. If this it not the case, it assumes that the aggregated score has been tampered with or that the message is replayed by an attacker. The parameters n, i, m can be set according to the needs of the actual setting/system.

There are several ways how to design and further develop the teaching of the present invention in an advantageous way. To this end, it is to be referred to the patent claim subordinate to patent claim 1 on the one hand, and to the following explanation of a preferred example of an embodiment of the invention illustrated by the drawing on the other hand. In connection with the explanation of the preferred example of an embodiment of the invention by the aid of the drawing, generally preferred embodiments and further developments of the teaching will be explained. In the drawing

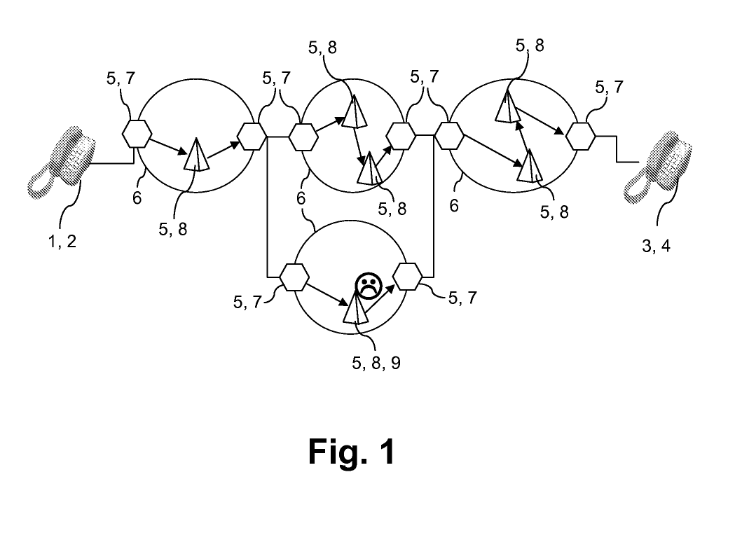

FIG. 1 illustrates a first embodiment of an application scenario of the method according to the invention, and

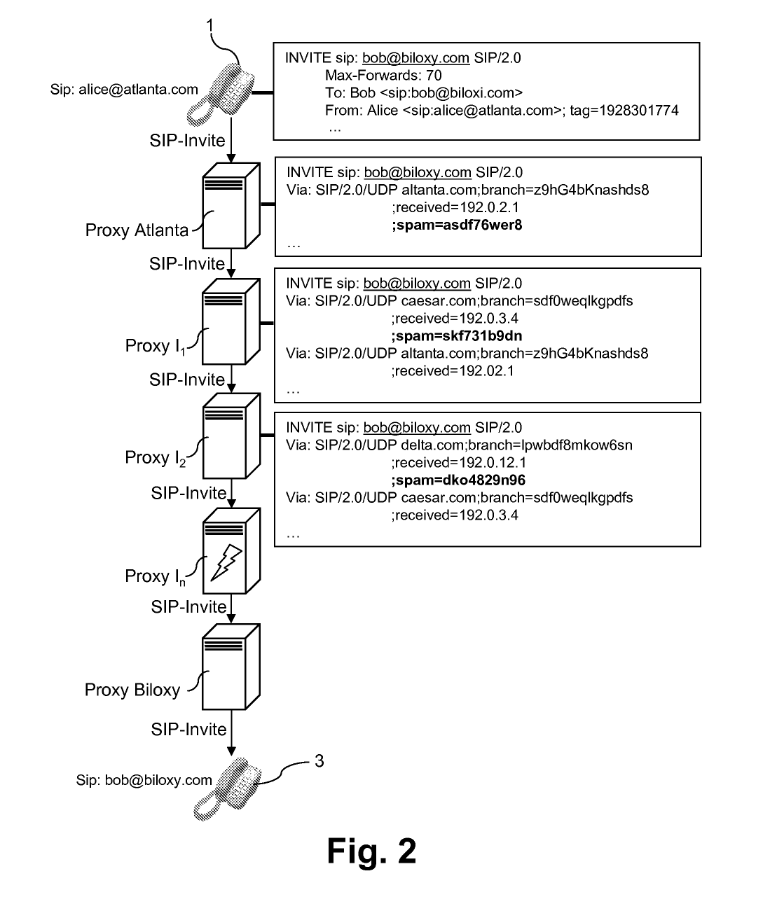

FIG. 2 illustrates a second embodiment of an application scenario of the method according to the invention.

FIG. 1 shows a general setting in which an originating network node 1—caller 2—initiates a communication session with a destination network node 3—callee 4. Appropriate messages for communication session establishment are routed through the network along a network path from the caller 2 to the callee 4, thereby transiting hop-wise several intermediate network nodes 5. The intermediate network nodes 5 are illustrated by the hexagonal and the pyramidal symbols. More specifically, the communication session messages are routed through different domains 6 symbolized by the ellipses. The hexagonal symbols constitute session border controllers (SBCs) 7 which are transited by the session messages when entering a network domain 6 and when leaving a network domain 6. In the special case shown in FIG. 1 the pyramidal symbols are proxy servers 8 which inspect the transiting messages and calculate a maliciousness score. The maliciousness score is encrypted, and the encrypted value is appended to the session message and forwarded along the communication path towards the callee 4. By encryption of the maliciousness score it is assured that unauthorized parties do not see which maliciousness scores have been assigned to the message by previous network nodes along the communication path. Such unauthorized party is shown in the routing path in the lower part of FIG. 1 where the session message is routed through an untrusted proxy server 9. When the callee 4 receives the aggregated maliciousness scores, he decrypts the scores and, depending on the results, decides on further treatment of the communication session.

FIG. 2 illustrates an example of the method according to the invention in a specific application scenario of a SIP-based VoIP call. The call is established between an originating network node 1 which is alice@atlanta.com and a destination network node 3 which is bob@biloxy.com. For call establishment Alice sends a SIP-invite message towards Bob which is routed via proxy Atlanta, proxy I₁, proxy I₂, proxy Iₙ and proxy Biloxy. Proxies I₁ and I₂ are trusted ones, whereas proxy Iₙ is an untrusted one.

In the right part of FIG. 2 excerpts from the via-headers of the SIP-invite messages routed along the communication path are shown.

Starting now with proxy Atlanta, this server inspects the SIP-invite message received from Alice and calculates a SPIT-score on the basis of a specific methodology (e.g. Turing test, grey-listing, etc.). The SPIT score assigned to the message by proxy Atlanta is called “score_{Atlanta}”. By using an asymmetric homomorphic encryption labelled E, proxy Atlanta encrypts its SPIT score with the public key of the callee's proxy (denoted k_pub_{biloxy-domain}). Thus, the operation performed by proxy Atlanta is:

E₁=E(score_{Atlanta},k_pub_{biloxy-domain})=asdf76wer8

The encrypted SPIT score value E₁ is added to the via-header of the SIP invite message as shown in the upper right part of FIG. 2 which is then forwarded to proxy I₁.

Upon receipt of the SIP-invite message, proxy server I₁ performs basically the same operation as proxy server Atlanta, i.e. inspecting the message, calculating a SPIT score, and encrypting the calculated score with the public key of the callee's proxy. Proxy then adds the result to the encrypted SPIT score from the via-header of the previous hop (as present in the message), and adds the new sum as part of its via-header to the message. The operation performed by proxy I₁ can thus be written as

E₂=E₁+E(score_{I1},k_pub_{biloxy-domain})=skf731b9dn

In the same way the next hop along the signalling path, i.e. proxy server I₂, performs the operation:

E₃=E₂+E(score_{I2},k_pub_{biloxy-domain})=dko4829n96

The next hop along the communication path is proxy server Iₙ which is, as already mentioned above, an untrusted proxy and which therefore does not dispose of the public key of the caller's proxy. As a consequence, proxy server Iₙ can not eavesdrop on scores contributed by previous hops on the path.

Finally, the receiving end proxy, i.e. proxy Biloxy, receives the SIP-invite message which contains the SPIT score value E₃ in its via-header. Due to the property of the employed encryption as being additively homomorphic, the end proxy only has to decrypt one number, which is the final encrypted score in the via-header, i.e. E₃, to get the sum of the score of all trusted proxies. The according transformation to be performed by proxy Biloxy is:

D(E₃,k_priv_{biloxy-domain})=scoreₐₜₗₐₙₜₐ+score_{I1}+score_{I2}

where D denotes the decryption transformation and k_priv_{biloxy-domain} denotes the private key of proxy Biloxy.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for aggregating information values in a network, the network comprising trusted network nodes and untrusted network nodes, wherein a communication session is established by directing messages through the network along a network path from an originating network node (1) to a destination network node (3) thereby transiting hop-wise several intermediate network nodes (5, 7, 8, 9), wherein said information values are appended to said messages as per-hop information by network nodes (5, 7, 8, 9) along said network path, said appended information values being aggregated from hop to hop, characterized in that said information values are encrypted before being appended to said messages, wherein said aggregation is performed on the encrypted information values.

2. Method according to claim 1, wherein said messages to which said information values are appended are multimedia session messages.

3. Method according to claim 1, wherein said information values include scoring values indicating the maliciousness of said messages.

4. Method according to claim 3, wherein said maliciousness is determined by the network nodes (8) by means of applying specific methodologies.

5. Method according to claim 1, wherein said information values include scoring values which are generated by the network nodes (8) indicating the delay caused by the respective previous network node of the network path.

6. Method according to claim 1, wherein said information values include scoring values which are generated by the network nodes (8) and which are related to load-balancing information of the respective network node.

7. Method according to claim 1, wherein said information values include billing information per hop and/or per session and/or per domain.

8. Method according to claim 1, wherein said information values appended to said messages along said network path are summed up at the destination network node (3).

9. Method according to claim 1, wherein each of said network nodes (8) which appends an information value to said messages performs encryption separately.

10. Method according to claim 9, wherein the encrypted information values are appended in a list attached to said messages.

11. Method according to claim 1, wherein each of said network nodes (8) which appends an information value to said messages performs an additively homomorphic encryption transformation.

12. Method according to claim 1, wherein the encrypted information values appended to said messages are aggregated along said network path.

13. Method according to claim 1, wherein a symmetric homomorphic encryption scheme is used for encryption.

14. Method according to claim 1, wherein said trusted nodes constitute a federation.

15. Method according to claim 1, wherein all network nodes of said federation share a single symmetric key.

16. Method according to claim 1, wherein the network nodes of the federation share symmetric keys pairwise.

17. Method according to claim 1, wherein each network node (8) along said network path which appends an information value to said messages employs a key for encryption that it shares with a network node destined for decryption.

18. Method according to claim 1, wherein the identities of all network nodes (8) along said network path which append an information value to said messages are forwarded to a network node destined for decryption.

19. Method according to claim 17, wherein said network node destined for decryption is configured as to derive a master key from the shared keys corresponding to the set of received identities.

20. Method according to claim 1, wherein an asymmetric homomorphic encryption scheme is used for encryption.

21. Method according to claim 20, wherein the key of a network node destined for decryption is used as public key for encryption.

22. Method according to claim 1, wherein with each encryption a freshness code is incorporated into the ciphertexts.

23. Method according to claim 22, wherein said freshness code includes a freshness value in form of an arbitrary bit-string.

24. Method according to claim 23, wherein said freshness values are provided to all trusted network nodes in preset time intervals.

25. Method according to claim 1, wherein said intermediate network nodes include SIP proxy servers, application servers, and/or session border controllers.
